(19) United States
(12) Patent Application Publication
(10) Pub. No.: US 2015/0197699 A1
(43) Pub. Date: Jul. 16, 2015

(54) METHOD FOR PRODUCING CARBONIZED COAL, METHOD FOR WORKING BLAST FURNACE, AND METHOD FOR OPERATING BOILER

(71) Applicant: MITSUBISHI HEAVY INDUSTRIES, LTD., Tokyo (JP)

(72) Inventors: Setsuo Omoto, Tokyo (JP); Keiichi Nakagawa, Tokyo (JP); Tsutomu Hamada, Tokyo (JP); Masakazu Sakaguchi, Tokyo (JP)

(73) Assignee: MITSUBISHI HEAVY INDUSTRIES, LTD., Tokyo (JP)

(21) Appl. No.: 14/412,779

(22) PCT Filed: Sep. 13, 2013
(86) PCT No.: PCT/JP2013/074821

§ 371 Date: Jan. 5, 2015

(30) Foreign Application Priority Data
Sep. 20, 2012 (JP) 2012-206775

(51) Int. Cl. C10L 10/02; F27B 1/16; C10L 9/08

(52) U.S. Cl. CPC C10L 10/02; C10L 9/08; F27B 1/16; C10L 2290/02; C10L 2290/60

(57) ABSTRACT

Provided is a method for producing carbonized coal that enables production of carbonized coal in which the mercury content is reduced and excessive reduction of the volatile matter content is suppressed without carrying out complicated work. The method includes acquiring industrial analysis and elemental analysis data about raw coal (S11); performing a computation by using an amount of heat (A) obtained from the industrial analysis data or Dulong's formula, a fuel ratio (B) based on the industrial analysis data, a hydrogen content (C) in relation to the carbon content based on the elemental analysis data, and an oxygen content (D) in relation to the carbon content based on the elemental analysis data (S12); and deriving a carbonization temperature (T) of the raw coal and setting a temperature for carbonizing the raw coal on the basis of the carbonization temperature (T) of the raw coal (S13).

### TECHNICAL FIELD

The present invention relates to a method for producing pyrolized coal in which pyrolized coal is produced bypyrolizing coal, a method for running a blast furnace, and a method for operating a boiler.

### BACKGROUND ART

Raw-material coal (raw coal) contains mercury, and a technique for reducing the mercury content in the raw coal is studied. For example, Patent Document 1 listed below discloses a method for producing low mercury coal in which low mercury coal with low mercury content is produced by subjecting raw coal to heat treatment at a predetermined temperature on the basis of the mercury emission characteristics in the raw coal which shows a relationship between a heating temperature of the raw coal and the mercury emission amount in the raw coal.

### PRIOR ART DOCUMENT

### Patent Document

Patent Document 1: U.S. Pat. No. 5,403,365 (for example, see FIG. 3 and the like)

### SUMMARY OF THE INVENTION

### Problems to be Solved by the Invention

However, Patent Document 1 described above discloses only the method for producing low mercury coal on the basis of the mercury emission characteristics of raw coal produced in the Eagle Butte mine. In a case of producing low mercury coal from raw coal and the like produced in another mine, there is a need to obtain data on the mercury emission characteristics of this raw coal which are special data obtained through experiments. Work of obtaining data itself is thus cumbersome and may lead to an increase of production cost.

Moreover, when raw coal is subjected to heat treatment at a temperature simply set only for the purpose of obtaining low mercury coal by removing mercury from the raw coal, there is possibility that volatile matters in the raw coal are excessively removed and the ignitability of the obtained coal deteriorates.

Meanwhile, although high-rank coal (high-quality coal) among various types of coal is used as blast-furnace injected coal injected into a tuyere of a blast furnace facility and as fuel of a boiler, use of low-rank coal (low-quality coal) such as brown coal, subbituminous coal, and bituminous coal which are cheaper than the high-quality coal is studied. Since the low-quality coal contains a large amount of moisture and has a lower calorific value per unit weight than the high-quality coal, the low-quality coal is subjected to heat treatment to be dried and pyrolized and is thereby turned into pyrolized coal having an improved calorific value per unit weight. Since the low-quality coal also contains mercury, there may be a demand to reduce the mercury content of the pyrolized coal.

In view of this, the present invention has been made to solve the problems described above, and an object thereof is to provide a method for producing pyrolized coal, a method for running a blast furnace, and a method for operating a boiler in which pyrolized coal whose mercury content is reduced with excessive reduction of volatile matter content being suppressed can be produced without performing cumbersome work.

### Means for Solving the Problems

A method for producing pyrolized coal of a first aspect of the invention for solving the problems described above is a method for producing pyrolized coal in which pyrolized coal is produced by pyrolizing raw-material coal, characterized in that the method comprises:

obtaining proximate analysis data and ultimate analysis data on the raw-material coal;

deriving a pyrolizing temperature T of the raw-material coal from calculation expressed by formula (1), by using a calorific value A which is one type of the proximate analysis data or which is obtained from the Dulong's formula on the basis of the ultimate analysis data, a fuel ratio B which is based on the proximate analysis data, a hydrogen content C relative to a carbon content which is based on the ultimate analysis data, and an oxygen content D relative to the carbon content which is based on the ultimate analysis data; and

setting a temperature at which the raw-material coal is to be pyrolized on the basis of the pyrolizing temperature T of the raw-material coal,

T=t1+aA+bB+cC+dD (1)

where t1 is an intercept, a, b, c, and d are coefficients, and t1, a, b, c, and d satisfy 450≦t1≦475, 0.145≦a≦0.155, −640≦b≦−610, 1600≦c≦1700, and −540≦d≦−500, respectively.

A method for running a blast furnace of a second aspect of the invention for solving the problems described above is characterized in that pulverized coal produced by pulverizing the pyrolized coal produced in the method for producing pyrolized coal according to the first aspect is used as blast-furnace injection coal injected into a tuyere of a blast furnace facility.

A method for operating a boiler of a third aspect of the invention for solving the problems described above is characterized in that the pyrolized coal produced in the method for producing pyrolized coal according to the first aspect is used as fuel of a boiler.

### Effect of the Invention

In the method for producing pyrolized coal of the present invention, pyrolized coal whose mercury content is reduced with excessive reduction of volatile matter content being suppressed can be produced only by setting the temperature at which the raw-material coal is to be pyrolized to the pyrolizing temperature T of the raw-material coal obtained by substituting the calorific value, the fuel ratio, the hydrogen content relative to the carbon content, and the oxygen content relative to the carbon content which are obtained from the proximate analysis data and the ultimate analysis data on the raw-material coal and the Dulong's formula, into the aforementioned formula (1). Since the proximate analysis data and the ultimate analysis data on the raw-material coal are not special data but are the most basis data used to show the quality of the raw-material coal, there is no need to perform cumbersome work such as obtaining data on the mercury emission characteristics in the raw-material coal.

In the method for running a blast furnace and the method for operating a boiler of the present invention, since the pyrolized coal itself is coal whose mercury content is reduced, it is possible to greatly reduce the mercury content in combustion exhaust gas generated when the pyrolized coal is combusted. Moreover, since the pyrolized coal is coal in which excessive reduction of volatile matter content is suppressed, deterioration of ignitability of the pyrolized coal can be suppressed.

### BRIEF DESCRIPTION OF THE DRAWINGS

FIG. 1 is a flowchart showing procedures for setting a pyrolizing temperature in a method for producing pyrolized coal of the present invention.

FIG. 2 is a flowchart showing procedures in the method for producing pyrolized coal of the present invention.

### MODE FOR CARRYING OUT THE INVENTION

The present invention is not limited to the following embodiment in which a method for producing pyrolized coal, a method for running a blast furnace, and a method for operating a boiler of the present invention are described.

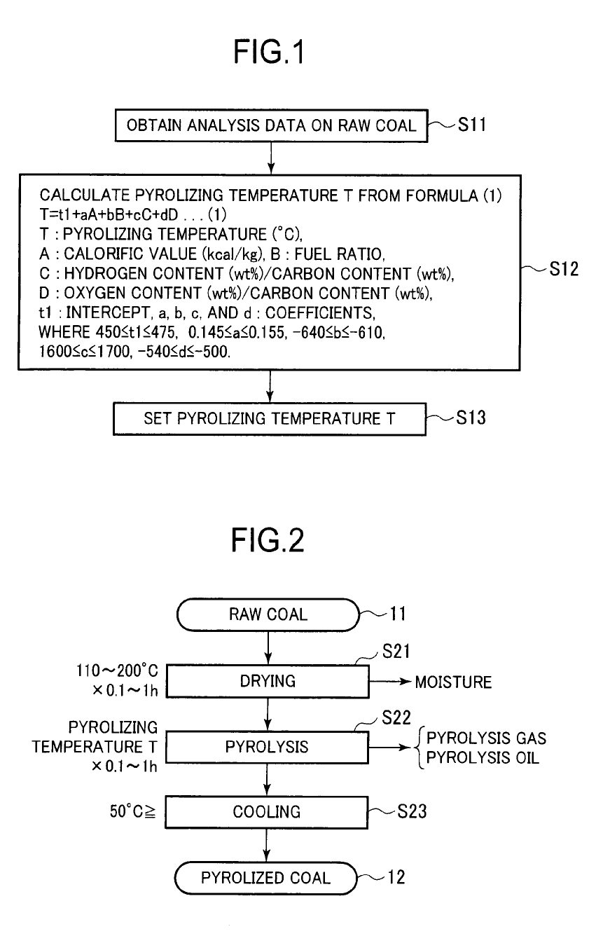

In the embodiment, specific description is given based on FIGS. 1 and 2.

In the embodiment, as shown in FIG. 2, raw coal 11 which is raw-material coal is dried by being heated (for example, at 110 to 200° C. for 0.1 to 1 hour) in a low-oxygen atmosphere (oxygen concentration: equal to or less than 5 volume percent) (drying step S21) to remove moisture. Thereafter, the coal is pyrolized by being heated (at a pyrolizing temperature T for 0.1 to 1 hour) in a low-oxygen atmosphere (oxygen concentration: equal to or less than 2 volume/weight percent) (pyrolizing step S22) to remove volatile matters (for example, H₂O, CO₂, tar, Hg, and the like) as pyrolysis gas and pyrolysis oil. Then, the coal is cooled (at a temperature equal to or lower than 50° C.) in a low-oxygen atmosphere (oxygen concentration: equal to or less than 2 volume percent) (cooling step S23), and pyrolized coal 12 is thus produced.

Here, the pyrolizing temperature T described above is set based on the following formula (1).

T=t1+aA+bB+cC+dD (1)

In the formula, T represents the pyrolizing temperature (° C.), A represents a calorific value (as received basis) (kcal/kg), B represents a fuel ratio, C represents a hydrogen content (wt %) relative to a carbon content (wt %) (H/C), D represents an oxygen content (wt %) relative to the carbon content (wt %) (O/C), t1 represents an intercept (constant), and a, b, c, and d represent coefficients, respectively.

Note that t1, a, b, c, and d are each set within a range shown in the following table 1.

TABLE 1

| | Coefficient (intercept) | t1 | a | b | c | d |
|---|---|---|---|---|---|---|
| Range of | Lower value | 450 | 0.145 | −640 | 1600 | −540 |
| coefficient | Higher value | 475 | 0.155 | −610 | 1700 | −500 |
| (intercept) | | | | | | |

Specifically, t1 satisfies 450≦t1≦475, a satisfies 0.145≦a≦0.155, b satisfies −640≦b≦−610, c satisfies 1600≦c≦1700, and d satisfies −540≦d≦−500.

For example, brown coal, subbituminous coal, bituminous coal, and the like are used as the raw coal 11. The percentage by weight (wt %) of total moisture (as received basis), the percentage by weight (wt %) of moisture (air dried), the percentage by weight (wt %) of ash, the percentage by weight (wt %) of volatile matters, and the percentage by weight (wt %) of fixed carbon which are composition analysis values of the raw coal are not special data, but are the most basic data used to show the quality of the raw coal and are data obtained from proximate analysis specified in, for example, JIS M8812 (2004) which is performed when the raw coal is produced or used. Moreover, the carbon content (wt %), the hydrogen content (wt %), the nitrogen content (wt %), the total sulfur content (wt %), the oxygen content (wt %), and the total mercury content (mg/kg) which are composition analysis values of the raw coal are also not special data, but are the most basic data used to show the quality of the raw coal and are data obtained from ultimate analysis specified in, for example, JIS M8813 (2004) which is performed when the raw coal is produced or used. The calorific value of the raw coal 11 is the most basic data used to show the quality of the raw coal and is data obtained from proximate analysis specified in, for example, JIS M8814 (2004) which is performed when the raw coal is produced or used.

The fuel ratio of the raw coal 11 is a ratio (fixed carbon wt %/volatile matters wt %) between the fixed carbon and the volatile matters obtained in the aforementioned proximate analysis.

Moreover, the aforementioned calorific value of the raw coal 11 can be obtained from the following formula (2), which is Dulong's formula, by using the percentages by weight of the respective elements (carbon, hydrogen, oxygen, and sulfur) obtained from the aforementioned ultimate analysis specified in JIS M8813 (2004).

H=81W_{C}+342.5(W_{H}−W_{O}/8)+22.5W_{S} (2)

In the formula, H represents the calorific value, W_{C} represents the percentage by weight of carbon in the raw coal, W_{H} represents the percentage by weight of hydrogen in the raw coal, W_{O} represents the percentage by weight of oxygen in the raw coal, and W_{S} represents the percentage by weight of sulfur in the raw coal.

In other words, as shown in FIG. 1, it is possible to produce the pyrolized coal 12 whose mercury content is reduced with excessive reduction of the volatile matter content being suppressed, only by: obtaining the proximate analysis data and the ultimate analysis data on the raw coal 11 (raw coal analysis data obtaining step S11); deriving the pyrolizing temperature T of the raw coal from the calculation expressed by the aforementioned formula (1), by using the calorific value which is one type of the proximate analysis data or the calorific value which is obtained from the aforementioned formula (2) being the Dulong's formula on the basis of the ultimate analysis data, the fuel ratio which is based on the proximate analysis data, the hydrogen content relative to the carbon content which is based on the ultimate analysis data, and the oxygen content relative to the carbon content which is based on the ultimate analysis (pyrolizing temperature calculating step S12); and setting the temperature at which the raw coal 11 is to be pyrolized to the pyrolizing temperature T of the raw coal (pyrolizing temperature setting step S13). Since the proximate analysis data and the ultimate analysis data on the raw coal 11 are not special data but are the most basic data used to show the quality of the raw coal 11, there is no need to perform cumbersome work such as obtaining data on the mercury emission characteristics in the raw coal 11.

Accordingly, in the method for producing pyrolized coal of the embodiment, there is no need to analyze the mercury emission characteristics of various types of coal and perform cumbersome work, and the pyrolized coal whose mercury content is reduced with excessive reduction of the volatile matter content being suppressed can be produced only by setting the temperature at which the raw coal 11 is to be pyrolized to the pyrolizing temperature T of the raw coal derived from the calculation of the aforementioned formula (1) by using the proximate analysis data and the ultimate analysis data which are the most basic data used to show the quality of the raw coal.

Since the pyrolized coal produced in the aforementioned method for producing pyrolized coal of the embodiment is coal with reduced mercury content, using pulverized coal obtained by crushing and pulverizing the pyrolized coal as blast-furnace injection coal injected into a tuyere of a blast furnace facility can greatly reduce the mercury content in combustion exhaust gas generated by combustion of the pyrolized coal compared to a case of using, as the blast-furnace injection coal, conventional pulverized coal produced by simply pulverizing PCI coal not subjected to the processing of reducing the mercury content in the coal. Since the pyrolized coal is coal in which excessive reduction of the volatile matter content is suppressed, deterioration of ignitability of the pyrolized coal can be suppressed.

Since the pyrolized coal produced in the aforementioned method for producing pyrolized coal of the embodiment is coal with reduced mercury content, using the pyrolized coal as fuel of a boiler can reduce the amount of mercury contained in combustion exhaust gas of the boiler compared to a case of using, as the fuel of the boiler, conventional coal obtained by simply performing pyrolysis or the like on raw coal not subjected to the processing of reducing the mercury content in the coal. Since the pyrolized coal is coal in which excessive reduction of the volatile matter content is suppressed, deterioration of ignitability of the pyrolized coal can be suppressed.

### Example

Description is given below of examples made to confirm operations and effects of the method for producing pyrolized coal, the method for running a blast furnace, and the method for operating a boiler of the present invention. However, the present invention is not limited to the following examples described based on various types of data.

### [Confirmation Test 1]

Test 1 was performed to confirm whether, when the aforementioned method for producing pyrolized coal of the embodiment is applied to cases where bituminous coal, subbituminous coal, and brown coal are used as the raw-material coal, pyrolized coal whose mercury content is reduced with excessive reduction of the volatile matter content being suppressed can be produced by setting the temperature at which the raw-material coal is to be pyrolized on the basis of the pyrolizing temperature T derived from the calculation of the aforementioned formula (1).

First, in the confirmation test 1, the proximate analysis data and the ultimate analysis data shown in the following table 2 were obtained for each of a test sample 1 (bituminous coal), a test sample 2 (subbituminous coal), and a test sample 3 (brown coal). Then, the pyrolizing temperatures T of the respective test samples 1 to 3 shown in the following table 5 were each derived from calculation expressed by the aforementioned formula (1), by using the calorific value which is one type of the proximate analysis data, the fuel ratio which is based on the proximate analysis data and which is shown in the following table 3, the hydrogen content relative to the carbon content which is based on the ultimate analysis data and which is shown in the following table 3, and the oxygen content relative to the carbon content which is based on the ultimate analysis data and which is shown in the following table 3. Note that t1, a, b, c, and d in the formula (1) were set to be within numerical ranges shown in the following table 4, respectively. Moreover, for comparison, a comparative sample 1 was prepared. The comparative sample 1 was the same type of coal as the test sample 2 and had the same composition as the test sample 2. However, as shown in the following table 4, only the value of the coefficient a of the comparative sample 1 was set different from those of the test samples 1 to 3 and was 0.128 which was outside the numerical range of the coefficient a in the aforementioned embodiment.

TABLE 2

| | | | Test sample 1 | Test sample 2 | Test sample 3 | Comparative sample 1 |
|---|---|---|---|---|---|---|
| Item | Basis | Unit | (bituminous coal) | (subbituminous coal) | (brown coal) | (subbituminous coal) |
| Total moisture | Received | wt % | 5.9 | 26.9 | 52.9 | 26.9 |
| Moisture | Air dried | wt % | 2.4 | 18.7 | 20.1 | 18.7 |
| Ash | Dry | wt % | 18.4 | 5.4 | 4.7 | 5.4 |
| Volatile matter | Dry | wt % | 33.6 | 43.6 | 54.9 | 43.6 |
| Fixed carbon | Dry | wt % | 48.0 | 51.0 | 40.4 | 51.0 |
| Carbon | Dry | wt % | 66.2 | 71.0 | 66.5 | 71.0 |
| Hydrogen | Dry | wt % | 4.4 | 3.6 | 5.0 | 3.6 |
| Nitrogen | Dry | wt % | 1.8 | 1.0 | 0.9 | 1.0 |
| Total Sulfur | Dry | wt % | 2.1 | 0.54 | 0.35 | 0.54 |
| Oxygen | Dry | wt % | 7.1 | 18.5 | 22.6 | 18.5 |
| Total mercury | Dry | mg/kg | 0.28 | 0.060 | 0.093 | 0.060 |
| Calorific value | Received | kcal/kg | 6150 | 4900 | 2890 | 4900 |

TABLE 3

| | | | | | | |
|---|---|---|---|---|---|---|
| | | | Test sample 1 | Test sample 2 | Test sample 3 | Comparative sample 1 |
| Item | Basis | Unit | (bituminous coal) | (subbituminous coal) | (brown coal) | (subbituminous coal) |

| | | | | | |
|---|---|---|---|---|---|
| Fuel ratio | | 1.43 | 1.17 | 0.74 | 1.17 |
| (raw coal) | | | | | |
| H/C | — | 0.066 | 0.051 | 0.075 | 0.051 |
| O/C | — | 0.11 | 0.26 | 0.34 | 0.26 |

TABLE 4

| | | Test sample 1 | Test sample 2 | Test sample 3 | Comparative sample 1 |
|---|---|---|---|---|---|
| Item | Unit | (bituminous coal) | (subbituminous coal) | (brown coal) | (subbituminous coal) |
| t1 (intercept) | — | 450 to 475 | 450 to 475 | 450 to 475 | 450 |
| a (coefficient) | — | 0.145 to 0.155 | 0.145 to 0.155 | 0.145 to 0.155 | 0.128 |
| b (coefficient) | — | −640 to −610 | −640 to −610 | −640 to −610 | −640 |
| c (coefficient) | — | 1600 to 1700 | 1600 to 1700 | 1600 to 1700 | 1600 |
| d (coefficient) | — | −540 to −500 | −540 to −500 | −540 to −500 | −540 |

TABLE 5

| | Item |
|---|---|
| | Pyrolizing temperature T |
| | (Lower limit of coefficient to |
| | upper limit of coefficient) |
| | Unit |
| | C. ° |
| Test sample 1 (bituminous coal) | 476 to 616 |
| Test sample 2 (subbituminous coal) | 352 to 477 |
| Test sample 3 (brown coal) | 335 to 432 |
| Comparative sample 1 (subbituminous | 269 |
| coal) | |

TABLE 6

| | Item | |
|---|---|---|
| | Mercury removal | Fuel ratio after |
| | rate (actual | pyrolysis (actual |
| | measurement) | measurement) |
| | Unit | |
| | % | — |
| Test sample 1 (bituminous coal) | 77 to 90 | 1.7 to 3.0 |
| Test sample 2 (subbituminous coal) | 77 to 85 | 1.8 to 2.8 |
| Test sample 3 (brown coal) | 75 to 97 | 1 to 1.5 |
| Comparative sample 1 | 50 | 1.35 |
| (subbituminous coal) | | |

Next, the aforementioned test samples 1 to 3 were pyrolized at the pyrolizing temperatures shown in the table 5 above. As a result, as shown in the table 6, it was confirmed that, in the coal of each of test samples 1 to 3, the fuel ratio after pyrolysis was equal to or lower than 3 and the mercury removal rate was equal to or higher than 75%. The aforementioned comparative sample 1 was pyrolized at 269° C. as shown in the table 5 above. As a result, as shown in the table 6, it was found that, although the fuel ratio after pyrolysis was 1.35 being equal to or lower than 3, the mercury removal rate was 50% and was lower than those of the test samples 1 to 3.

Accordingly, the following fact was confirmed from the confirmation test 1. Pyrolized coal whose mercury content is reduced with excessive reduction of the volatile matter content being suppressed can be obtained only by: obtaining the proximate analysis data and the ultimate analysis data on bituminous coal, subbituminous coal, and brown coal; and setting the temperature at which the raw coal is to be pyrolized on the basis of the pyrolizing temperature T derived by using the calorific value being one type of the proximate analysis data, the fuel ratio based on the proximate analysis data, the hydrogen content relative to the carbon content based on the ultimate analysis data, and the oxygen content relative to the carbon content based on the ultimate analysis data, and by setting t1, a, b, c, and d in the aforementioned formula (1) to satisfy 450≦t1≦475, 0.145≦a≦0.155, −640≦b≦−610, 1600≦c≦1700, and −540≦d≦−500, respectively.

Meanwhile, in the comparative sample 1, great reduction (reduction to a target level) of the mercury content could not be achieved only by setting the coefficient a in the aforementioned formula (1) outside the numerical range of a in the aforementioned embodiment. Accordingly, it is assumed that, even if the intercept t1 and the coefficients b, c, and d in the aforementioned formula (1) are set outside the numerical ranges of the intercept t1 and the coefficients b, c, and d in the aforementioned embodiment, it is impossible to obtain the appropriate pyrolizing temperature range and greatly reduce the mercury contents as in the comparative sample 1 in which only the coefficient a was set outside the numerical range.

### [Confirmation Test 2]

Test 2 was performed to confirm whether the pyrolizing temperature (target value), which is obtained based on the mercury content and the volatile matter content in the raw coal in the method for producing pyrolizing coal of the aforementioned embodiment and at which pyrolized coal whose mercury content is reduced with excessive reduction of the volatile matter content being suppressed can be obtained, is included in the range of pyrolizing temperature (calculation value) derived from the calculation of the aforementioned formula (1) by using the proximate analysis data and the ultimate analysis data. Note that the intercept t1 and the coefficients a, b, c, and d in the aforementioned formula (1) were set to satisfy 450≦t1≦475, 0.145≦a≦0.155, −640≦b≦−610, 1600≦c≦1700, and −540≦d≦−500, respectively.

TABLE 7

| | Pyrolizing temperature | | |
|---|---|---|---|
| | Lower limit value | Upper limit value | |
| | (calculation value) | (calculation value) | Target value |
| Test sample A | 335 | 432 | 350 |
| Test sample B | 352 | 477 | 375 |
| Test sample C | 476 | 616 | 500 |
| Test sample D | 548 | 699 | 550 |
| Test sample E | 536 | 681 | 600 |
| Test sample F | 469 | 626 | 500 |

The test sample A is brown coal. As shown in the table 7 above, it was found that the pyrolizing temperature (target value) was included in the range of pyrolizing temperature (calculation value) derived from the calculation of the aforementioned formula (1) by using the proximate analysis data and the ultimate analysis data.

The test sample B is subbituminous coal. As shown in the table 7 above, it was found that the pyrolizing temperature (target value) was included in the range of pyrolizing temperature (calculation value) derived from the calculation of the aforementioned formula (1) by using the proximate analysis data and the ultimate analysis data.

The test sample C is bituminous coal. As shown in the table 7 above, it was found that the pyrolizing temperature (target value) was included in the range of pyrolizing temperature (calculation value) derived from the calculation of the aforementioned formula (1) by using the proximate analysis data and the ultimate analysis data.

The test sample D is bituminous coal different from the test sample C. As shown in the table 7 above, it was found that the pyrolizing temperature (target value) was included in the range of pyrolizing temperature (calculation value) derived from the calculation of the aforementioned formula (1) by using the proximate analysis data and the ultimate analysis data.

The test sample E is bituminous coal different from the test samples C and D. As shown in the table 7 above, it was found that the pyrolizing temperature (target value) was included in the range of pyrolizing temperature (calculation value) derived from the calculation of the aforementioned formula (1) by using the proximate analysis data and the ultimate analysis data.

The test sample F is bituminous coal different from the test samples C, D, and E. As shown in the table 7 above, it was found that the pyrolizing temperature (target value) was included in the range of pyrolizing temperature (calculation value) derived from the calculation of the aforementioned formula (1) by using the proximate analysis data and the ultimate analysis data.

Accordingly, the following fact was confirmed from the confirmation test 2. Since the pyrolizing temperature (calculation value) derived from the calculation of the aforementioned formula (1) by using the proximate analysis data and the ultimate analysis data includes the pyrolizing temperature (target value) which is obtained based on the mercury content and the volatile matter content of the raw coal and at which pyrolized coal whose mercury content is reduced with excessive reduction of the volatile matter content being suppressed can be obtained, pyrolized coal whose mercury content is reduced with excessive reduction of the volatile matter content being suppressed can be obtained by pyrolizing the raw coal at the pyrolizing temperature (calculation value).

### INDUSTRIAL APPLICABILITY

In the method for producing pyrolized coal, the method for running a blast furnace, and the method for operating a boiler of the present invention, pyrolized coal whose mercury content is reduced with excessive reduction of the volatile matter content being suppressed can be produced without performing cumbersome work. Accordingly, the methods of the present invention can be very useful in the steel industry and the power generation industry.

### EXPLANATIONS OF REFERENCE NUMERALS

11 RAW COAL (RAW-MATERIAL COAL)
12 PYROLIZED COAL
S11 RAW COAL ANALYSIS DATA OBTAINING STEP
S12 PYROLIZING TEMPERATURE CALCULATING STEP
S13 PYROLIZING TEMPERATURE SETTING STEP
S21 DRYING STEP
S22 PYROLIZING STEP
S23 COOLING STEP

1. A method for producing pyrolized coal in which pyrolized coal is produced by pyrolizing raw-material coal, characterized in that the method comprises:
obtaining proximate analysis data and ultimate analysis data on the raw-material coal;
deriving a pyrolizing temperature T of the raw-material coal from calculation expressed by formula (1), by using a calorific value A which is one type of the proximate analysis data or which is obtained from the Dulong's formula on the basis of the ultimate analysis data, a fuel ratio B which is based on the proximate analysis data, a hydrogen content C relative to a carbon content which is based on the ultimate analysis data, and an oxygen content D relative to the carbon content which is based on the ultimate analysis data; and
setting a temperature at which the raw-material coal is to be pyrolized on the basis of the pyrolizing temperature T of the raw-material coal,
T=t1+aA+bB+cC+dD (1)
where t1 is an intercept, a, b, c, and d are coefficients, and t1, a, b, c, and d satisfy 450≦t1≦475, 0.145≦a≦0.155, −640≦b≦−610, 1600≦c≦1700, and −540≦d≦−500, respectively.

2. A method for running a blast furnace, characterized in that pulverized coal produced by pulverizing the pyrolized coal produced in the method for producing pyrolized coal according to claim 1 is used as blast-furnace injection coal injected into a tuyere of a blast furnace facility.

3. A method for operating a boiler, characterized in that the pyrolized coal produced in the method for producing pyrolized coal according to claim 1 is used as fuel of a boiler.
